(19) United States
(12) Patent Application Publication
(10) Pub. No.: US 2021/0277191 A1
(43) Pub. Date: Sep. 9, 2021

(54) GENERIC METHOD FOR STRUCTURING HYDROGELS

(71) Applicants: ALVEOLE, Paris (FR); Centre National de la Recherche Scientique, Paris (FR); Université de Bordeaux, Bordeaux (FR)

(72) Inventors: Vincent Studer, Bordeaux (FR); Aurélien Pasturel, Valréas (FR)

(73) Assignees: ALVEOLE, Paris (FR); Centre National de la Recherche Scientique, Paris (FR); Université de Bordeaux, Bordeaux (FR)

(21) Appl. No.: 17/255,717

(22) PCT Filed: Jun. 27, 2019
(86) PCT No.: PCT/EP2019/067137

§ 371 Date: Dec. 23, 2020

(30) Foreign Application Priority Data
Jun. 27, 2018 (FR) 1855812

(51) Int. Cl. C08J 3/075; C08J 3/28

(52) U.S. Cl. CPC C08J 3/075; C08J 3/28; C08J 2305/12; C08J 2371/02; C08J 2333/26

(57) ABSTRACT

A subtractive method for structuring a hydrogel, comprising the following steps: producing a hydrogel layer containing benzophenone (3) on a substrate (6), the hydrogel not having any photocleavable group; bringing the hydrogel layer into contact with an oxygen tank (4); selectively illuminating the hydrogel layer with a light (5) capable of activating the benzophenone in order to convert the illuminated zone of the hydrogel layer into a liquid; and eliminating the liquid.

### TECHNICAL FIELD

The present invention relates to a generic method or process for microstructuring hydrogels by means of light.

### BACKGROUND

The micromanufacturing or microstructuring of hydrogels by means of light is carried out in a manner known in the prior art, notably for particular hydrogels, by using a photocleavable group directly grafted in the gel precursor (“Photo-degradable hydrogels for dynamic tuning of physical and chemical properties”, Science. Apr. 3, 2009; 324(5923): 59-63) or by means of so-called “femtosecond” ultra-high power infrared lasers, scanned point by point on the surface of any hydrogel (“Laser photo-ablation of guidance microchannels into hydrogels directs cell growth in three dimensions”, Biophysical Journal Vol. 96, June 2009, 4743-4752).

However, no means exists in the prior art for degrading hydrogels of very varied nature (not possessing a photocleavable group) in open field or in wide field, i.e. on a multitude of points of a surface, simultaneously.

### General Presentation

In this context, the invention relates to a subtractive method for structuring a hydrogel comprising the following steps:
producing a hydrogel layer containing a benzophenone on a substrate;
bringing the hydrogel layer into contact with an oxygen reservoir;
selectively illuminating the hydrogel layer with light, to transform it into a liquid; and
removing the liquid.

As stated above, the invention relates in particular to hydrogels not possessing a photocleavable group, i.e. hydrogels that are not photodegradable.

It is the illumination of the hydrogel layer with light capable of activating benzophenone that makes it possible, in the presence of oxygen and owing to activation of the benzophenone, to transform the illuminated zone of the hydrogel layer into liquid.

In the present account, “oxygen reservoir” denotes any means for guaranteeing the presence of oxygen necessary for the aforementioned transformation and, more precisely, for the phenomenon of photo-scission of the matrix of the hydrogel, discovered by the inventors. The air may constitute an oxygen reservoir of this kind.

In variants of the method, the following provisions are adopted independently or combined with one another:
the hydrogel is a polyethylene glycol (PEG);
the hydrogel is an agarose gel;
the hydrogel is an extract of basement membrane matrix;
the hydrogel is a polyacrylamide;
selective illumination is carried out along a channel, extending in the hydrogel;
selective illumination is obtained by means of a source emitting light between 315 and 400 nm, in particular at 375 nm;
selective illumination is obtained via a microscope and extends in a wide field of the microscope;
the benzophenone is a PLPP ((4-benzoylbenzyl)trimethylammonium chloride);
the source comprises a continuous laser and a spatial modulator;
the spatial modulator is an array of micromirrors or “Digital Micromirror Device” (DMD).

The aforementioned features and advantages, as well as others, will become clearer on reading the detailed description of embodiment examples given hereunder. This detailed description refers to the appended drawings. It is pointed out, however, that the invention is not limited to these examples.

### BRIEF DESCRIPTION OF THE DRAWINGS

FIG. 1 (FIG. 1) shows two states of a hydrogel submitted to the method of the invention: a first state (A) and a second state (B).

### DETAILED DESCRIPTION OF EMBODIMENTS

Cell culture in physiological conditions requires creating hydrogels that reproduce the shapes, the forces and the chemical signals that surround the cells and determine their behavior.

However, production of hydrogels that are finely conformable and adaptable in dimension usually requires large investments in chemistry and/or in high-power optical equipment.

For the majority of hydrogels there is thus a need for a sufficiently general means, applicable to their micromachining, notably subtractive, for removing hydrogel from its surface and hollow it out or for making microchannels inside a layer of any hydrogel.

In fact, production of this kind allows us to envisage growing, on the hydrogel layers, thus modified or machined, notably neurons or cell lines that are useful in cell biology.

In the present application, a hydrogel will be considered to be a soft two-phase assembly consisting of a liquid phase, which is an aqueous solution, and a solid phase or matrix, of low hardness or soft or viscoelastic.

The general inventive concept of the invention is then, in this context, selectively exposing to light or illuminating a hydrogel, the liquid phase of which contains or comprises oxygen and a benzophenone. The inventors have in fact discovered a new effect of photo-scission of the matrix of a hydrogel, associated with this operation, by which the solid part of the illuminated hydrogel is transformed either into liquid, or into small pieces or radicals, carried by the liquid phase of the hydrogel and transportable through the matrix of the hydrogel with this liquid phase. It is then possible to remove and renew the liquid phase by rinsing, notably with water, to remove the light-exposed solid parts of the hydrogel, which are literally liquefied, as well as the benzophenone contained in the liquid phase of the hydrogel, finally obtaining a hydrogel physically structured subtractively in the light-exposed parts and matrix that is not modified chemically otherwise.

The inventors discovered that the phenomenon of photo-scission in the presence of benzophenone (or photoinitiator) and oxygen was applicable, surprisingly, to numerous types of hydrogels and that it could be applied at least to the hydrogels that allow diffusion of the selected benzophenone and of oxygen within their matrix, via their liquid phase.

In all the embodiments of the invention, the hydrogel to be microstructured will have to be in contact with an oxygen reservoir allowing it to be renewed by diffusion in the liquid phase; the inventors have in fact observed that the oxygen is consumed or that in any case its concentration decreases in the liquid phase during photo-scission of the matrix.

In all the embodiments of the invention, the photoinitiator of photo-scission is water-soluble, more particularly the photoinitiator of photo-scission is a water-soluble benzophenone and, in particular, the photoinitiator of photo-scission is a water-soluble benzophenone of the PLPP type or (4-benzoylbenzyl)trimethylammonium chloride.

In all the embodiments of the invention, the hydrogel is assumed to be transparent to the source of selective illumination used and permeable to oxygen, so as to be able to obtain a deep structuring effect, the photo-scission taking place uniformly throughout the illuminated volume.

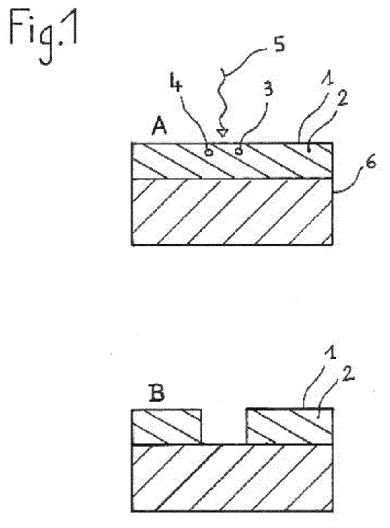

In a first embodiment, referring to FIG. 1, a hydrogel, for example a PEG hydrogel deposited on a substrate 6, is submitted to the method of the invention and passes from a first state A to a second state B. In the first state A, the hydrogel containing or comprising a PEG 1 and water 2, also contains a benzophenone 3 and oxygen 4 and is illuminated with light 5. After an exposure time and rinsing with water, the hydrogel passes into the second state B, in which matter of the hydrogel has been subtracted at the place of exposure and in which the benzophenone 3 has disappeared, leaving, in the hydrogel, a channel or trench, hollowed out as far as the substrate 6. In other words, the hydrogel being removed uniformly from the zone of the hydrogel that has been illuminated, the subtracted matter forms a hole opening onto the substrate 6 or a trench or a channel, in the sense of a furrow passing through the hydrogel as far as the substrate 6.

In this first embodiment, a PEG or polyethylene glycol hydrogel is thus used. PEG is in fact known for its great biocompatibility, making it the material of choice for microprinting of proteins and culturing of living cells.

In this manner, to reach the first state A, a PEG layer is brought into contact uniformly with an aqueous solution containing benzophenone 3. Typically, this layer is rinsed with an aqueous solution containing the water-soluble benzophenone PLPP.

Therefore at the end of this preliminary rinsing, the liquid phase of the hydrogel contains benzophenone. As the benzophenone molecules are small, they can be close to the matrix of the hydrogel, without being attached to it.

The hydrogel thus prepared is therefore, in the sense of the invention, a hydrogel containing or comprising a benzophenone (“containing or comprising” applying to its liquid phase). This definition applies in all the embodiments.

Then, the PEG layer is brought into contact with a uniform layer of oxygen, via an oxygen reservoir or store, in a known manner. The molecules of oxygen then also diffuse in the liquid phase of the hydrogel, which then contains a mixture of water, benzophenone and oxygen 4.

The gel or hydrogel is then illuminated selectively with light 5, i.e. according to a spatial pattern, for a variable time by means of a source emitting in an absorption band of the benzophenone, for example a source emitting light having a wavelength of 375 nm, such as a laser.

The source used is for example a laser source of reference TOPTICA iBeam-SMART 375-S emitting at 375 nm and with optical power of 75 mW. Any source of UV-A (emitting between 315-400 nm) and with power of the same order of magnitude as the aforementioned source, would however be capable of activating the benzophenone and triggering the photo-scission mechanism.

It is particularly remarkable that this source is not a pulsed source of a kind to volatilize the matrix but is on the contrary of low power for a continuous laser source. It is even more remarkable that the source used can be distributed over the field of a microscope while preserving the photo-scission effect and that therefore this power also corresponds to a low level of illumination in the hydrogel, which makes it possible to obtain photo-scission in a limited time, estimated experimentally to be of the order of 2000s but at all points of the field, i.e. in wide field and therefore in parallel at all the points of the volume of the hydrogel, if it is transparent to the light of the source used or close to its surface otherwise.

It should be noted that the selective illumination may also be carried out with a low numerical aperture, this feature further decreasing the illumination at a point but making it possible to obtain, with the method of the invention, microstructured surface cutouts approximately parallel to the middle ray of the illumination beam, which notably makes it possible for channels with straight flanks to be obtained with the invention.

It is therefore noted that based on photo-ablation of a hydrogel, by a so-called “femtosecond” laser of high energy in relation to the duration of its pulses, a laser which is by its nature as focused as possible on the surface, and with the highest possible numerical aperture, a person skilled in the art would not obtain the invention by decreasing the power of the laser.

It will further be noted that a person skilled in the art, performing photocleavage with hydrogels modified by chemical radicals attached to the matrix, would not obtain the photo-scission effect of the invention, which appears from the standpoint of the hydrogel as a physical effect and therefore of a different nature than photocleavage.

In a second embodiment, an agarose gel known from the prior art was used with the same results, notably production of trenches in the gel (i.e. furrows hollowed out in the gel as far as the substrate), these possibilities of production extending to all the embodiments of the invention. With the same method and the same device as for PEG, a structuring was thus obtained for an agarose gel of this kind. It is found experimentally that the photo-scission time in an agarose hydrogel is of the order of 20000 s (seconds), i.e. a duration ten times longer than in a PEG hydrogel.

In a third embodiment, a hydrogel extracted from basement membrane known by the trade name “Matrigel” was used. This hydrogel is fully biocompatible and very widely used for three-dimensional (3D) cell culture by virtue of a viscoelasticity that is very favorable to said culture. However, this hydrogel lacks a chemical functional group allowing its photocleavage and therefore its structuring. Although it can be hardened with UV when mixed with a photoinitiator, this operation alters its viscoelastic properties, thereby reducing its usefulness for cell culture. In any case, no means exists in the prior art for microstructuring it subtractively or by removing matter using light. The photo-scission time was estimated experimentally at 6000 s (seconds) in “Matrigel”.

The method or process of the invention may be carried out in the same way as for the preceding two embodiments. Moreover, it is possible to obtain heterogeneous hydrogels of PEG and “Matrigel” (“Matrigel” is produced, for example, by Corning Lab Sciences or BD Sciences). In fact it is observed experimentally that photo-scission is much slower in “Matrigel” than in PEG. It is therefore possible to use a “Matrigel” layer as substrate when we wish to structure a PEG layer by depositing this PEG layer on a “Matrigel” layer, deposited in its turn on a glass or plastic substrate or on a film of PDMS, as applicable.

It is also possible with the method according to the invention to obtain heterogeneous hydrogels of extract from basement membrane matrix, in particular of “Matrigel”, and of PEG, in the plane of a PEG layer. For this, first a structure of microfluidic channels is created in the PEG layer, using the method of the invention, and these channels are filled with “Matrigel”, then the method of the invention is repeated on the “Matrigel” to obtain its structuring in the structure of the PEG channels. For this it is convenient to use a membrane, notably of PDMS, that is permeable to oxygen and to the photoinitiator, and arranged in contact with the zones to be removed by illumination. This membrane notably makes it possible to limit the extent of the Matrigel in the plane of the layer, to the structure of channels in the PEG. As PDMS (polydimethylsiloxane) is transparent to UV, it will moreover be possible to choose to illuminate first via this membrane (rather than via the substrate) in the direction of propagation of the light, notably for implementing the invention with a substrate with little or no transparency to the light used for obtaining photo-scission. In all the embodiments of the invention, in the absence of membrane, it will also be possible to illuminate via the layer farthest from the substrate, when the latter has little or no transparency.

The method or process of the invention may be carried out in the same way as for the preceding embodiments with a hydrogel that is an aqueous gel or polyacrylamide hydrogel, a polymer with the chemical formula [—CH2-CH(—CONH2)-]n. The photo-scission time was estimated experimentally at 4000 s (seconds) in a polyacrylamide hydrogel.

The method according to the invention thus appears to be capable of producing numerous structures in homogeneous or heterogeneous hydrogels for 2D or 3D cell culture.

For selection of a hydrogel in which the benzophenone that is soluble in water (and by extension in hydrogels) is able to diffuse, it will be possible to utilize the properties of photoluminescence of the benzophenone, for quantifying the suitability of a hydrogel for the invention, without carrying out the method of the invention. For this, according to known techniques, it will be possible to measure the photoluminescence of benzophenone as a function of time, in one or more precise points, to select a hydrogel. The highest rate of diffusion of the benzophenone in the hydrogel matrix will thus be preferred.

Similarly, a hydrogel in which the rate of diffusion of oxygen is greater than in another, for identical biocompatibility of the two hydrogels, will be preferred for the invention.

Advantageously, the illumination system of the invention will comprise a microscope and a DMD (set of micromirrors controlled individually by a computer or automated) to allow illumination of the hydrogel according to an arbitrary pattern and to structure it in various ways.

The teaching of the invention extends to a substrate of various kinds. The substrate may in fact be completely insensitive to photo-scission, or degraded more slowly by photo-scission than the hydrogel that it supports. Examples of substrates that are insensitive to photo-scission are glass and plastic or a film of PDMS (polydimethylsiloxane or dimethicone). According to another example of substrate, as mentioned above, a “Matrigel” layer, which undergoes photo-scission at a much slower rate than “PEG”, may be used as substrate for a PEG hydrogel, relative to which it photodegrades more slowly.

The teaching of the invention also extends to obtaining a structured stack of several hydrogels in superposed layers on a substrate and also extends to the stack itself obtained by the method of the invention.

Notably, the teaching of the invention extends to a stack comprising at least two layers, having different photo-scission times.

It will in fact be possible with such stacks to obtain complex structures by the method of the invention, by successively applying this method to each layer to be removed and by adapting the illumination time and the illumination pattern to the layer intended to be illuminated.

In the case of two hydrogel layers on a substrate: for a sacrificial layer, it will thus be possible to select a photo-scission time that decreases toward the substrate and for steps descending toward the substrate, it will be possible to select a photo-scission time increasing toward the substrate as well as areas of illumination decreasing toward the substrate.

In all cases, the principle applied will be to transform an illuminated part of a hydrogel into liquid and remove it, without liquefying another hydrogel, with a longer photo-scission time.

Thus, with the method of the invention, a person skilled in the art will be able to structure, subtractively, a stack of hydrogels, based on simple knowledge of the photo-scission time for each type of hydrogel present in the stack.

Conveniently, a person skilled in the art will obtain this structuring just once in the full field or wide field of an automated illumination system, both for one layer of the stack or for several at once, as a function of the photo-scission time in the stack, the illumination time and the pattern illuminated in the stack.

The method of the invention and the numerous products that can be obtained by this method therefore finally make it a general means of structuring a hydrogel layer or a stack of hydrogel layers on a substrate, by removal of matter.

The method according to the invention is capable of industrial application in the field of three-dimensional (3D) culture of cells on a hydrogel layer or on a stack of hydrogel layers.

1. A subtractive method for structuring a hydrogel comprising the following steps:
producing a hydrogel layer containing a benzophenone on a substrate, the hydrogel not possessing a photocleavable group;
bringing the hydrogel layer into contact with an oxygen reservoir;
selectively illuminating the hydrogel layer with light capable of activating the benzophenone, to transform the illuminated zone of the hydrogel layer into a liquid;
removing the liquid.

2. The method as claimed in claim 1, in which the hydrogel is a polyethylene glycol.

3. The method as claimed in claim 1, in which the hydrogel is an agarose gel.

4. The method as claimed in claim 1, in which the hydrogel is an extract of basement membrane matrix.

5. The method as claimed in claim 1, in which the hydrogel is a polyacrylamide.

6. The method as claimed in claim 1, in which the selective illumination is carried out along a channel extending in the hydrogel.

7. The method as claimed in claim 1, in which the selective illumination is obtained by means of a light source emitting between 315 and 400 nm.

8. The method as claimed in claim 7, in which the light source emits light at 375 nm.

9. The method as claimed in claim 1, in which the selective illumination is obtained via a microscope and extends in a wide field of the microscope.

10. The method as claimed in claim 1, in which the benzophenone is a PLPP ((4-benzoylbenzyl)trimethylammonium chloride).

11. The method as claimed in claim 7, in which the light source comprises a continuous laser and a spatial modulator.

12. The method as claimed in claim 11, in which the spatial modulator is an array of micromirrors.

13. The method as claimed in claim 8, in which the light source comprises a continuous laser and a spatial modulator.
